(19) United States
(12) Patent Application Publication
(10) Pub. No.: US 2009/0094122 A1
(43) Pub. Date: Apr. 9, 2009

(54) SYSTEM AND METHOD OF COMPLETING A TRANSACTION INCLUDING PAYMENT VERIFICATION

(76) Inventors: Todd W. Lakes, Atlanta, GA (US); Clyde L. Dishman, Grayson, GA (US)

Correspondence Address: PAUL W. MARTIN, NCR CORPORATION, LAW DEPT., 1700 S. PATTERSON BLVD., DAYTON, OH, 45479-0001, US

(21) Appl. No.: 11/868,997

(22) Filed: Oct. 9, 2007

(51) Int. Cl. G06Q 20/00

(52) U.S. Cl. 705/16; 235/383; 705/26

(57) ABSTRACT

A system and method of completing a self-service transaction including payment verification which limits products or services to those paid for. The system includes a payment station and a delivery station. The payment station includes a first computer for recording an order from a customer, for processing payment for the order from the customer, for storing terms of the order with an order identification number, for providing an order identifier associated with the order identification number. The delivery station includes a second computer for reading the order identifier to determine the order identification number, for accessing the terms of the order using the order identification number, for authorizing a delivery to the customer based upon the terms of the order.

### BACKGROUND

Finding and retaining employees to provide service to customers can be difficult and expensive. Automation equipment is often employed to help resolve this issue.

In some self-service environments, payment may be completed at a location separate from where a product or service is provided or delivered, requiring customers to act in good conscious. This may lead to freeloading, sweet-hearing, or just excessive use.

It would be desirable to provide a system and method of completing a self-service transaction including payment verification and to limit products or services to those paid for.

### SUMMARY

A system and method of completing a self-service transaction including payment verification is provided.

The system includes a payment station and a delivery station. The payment station includes a first computer for recording an order from a customer, for processing payment for the order from the customer, for storing terms of the order with an order identification number, for providing an order identifier associated with the order identification number. The delivery station includes a second computer for reading the order identifier to determine the order identification number, for accessing the terms of the order using the order identification number, for authorizing a delivery to the customer based upon the terms of the order.

### BRIEF DESCRIPTION OF THE DRAWINGS

FIG. 1 is a block diagram of an example self-service system.

FIG. 2 is a flow diagram illustrating a self-service transaction method.

### DETAILED DESCRIPTION

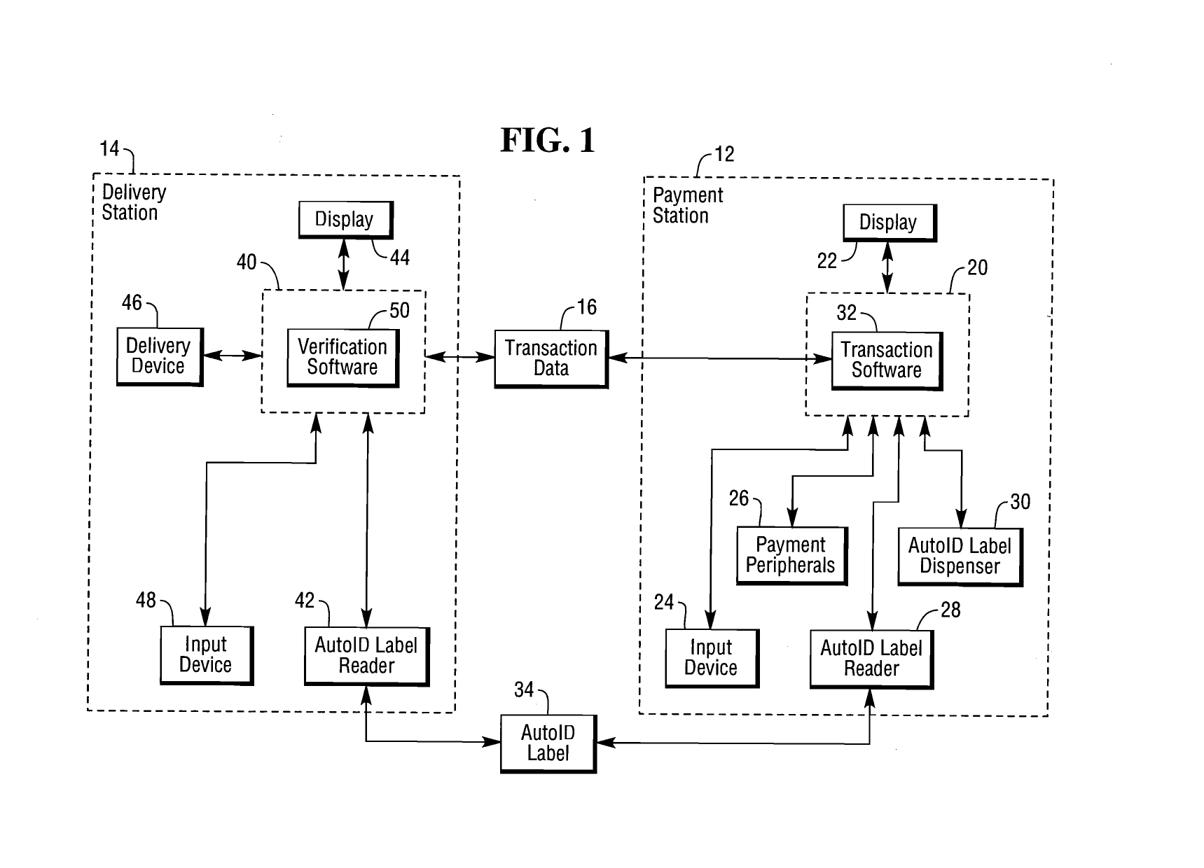

Referring now to FIG. 1, self-service system 10 includes payment station 12, delivery station 14, and transaction data 16. Payment station 12, Delivery station 14, and transaction data 16 may be coupled together via a network.

Payment station 12 processes payment for the product or service from the customer. Payment station 12 may include a computer 20, display 22, input device 24, and payment peripherals 26.

Computer 20 executes transaction software 32 for processing transactions involving products or services.

Display 22 displays a user interface generated by transaction software 32 for facilitating interactions between an operator and computer 20.

Input device 24 records operator inputs and selections used by transaction software 32 during transactions.

Payment peripherals 26 process payment for products or services. Payment peripherals 26 may include a check reader and a card reader, such as a credit, debit, smart, or wireless payment card reader.

After a customer provides payment for a product or service, payment station 12 associates the terms of the transaction with a unique identification number. Payment station 12 further associates the unique identification number with autoID label 34 and stores the association in transaction data 16.

Payment station 12 may include an assisted-service payment station or a self-service payment station. In an assisted-service mode of operation, payment station 12 may include autoID reader 28 for reading autoID label 34.

AutoID label 34 may include a barcode label or radio frequency identification (RFID) label. AutoID reader 28 may include a barcode reader or RFID reader.

In a self-service mode of operation, payment station 12 may include additional payment peripherals 26, such as currency and coin acceptors and dispensers. Payment station 12 may also include an automated dispenser 30 of autoID labels 34 under control of computer 20. For example, automated dispenser 30 may dispense autoID labels 34 with predetermined identification numbers in a predetermined order. Transaction software 32 may be programmed or provided with the identification numbers and the predetermined order in advance of any transactions.

Payment station 12 may dispense autoID labels 34 in conjunction with a carrier, such as a plastic or paper card. As another example, if the customer is purchasing a drink, autoID label 34 may be affixed to a cup provided to the customer at the time of purchase. In the case of services, autoID label 34 may be affixed to a ticket, card, bracelet or other device provided to the customer following payment.

The customer takes autoID label 34 to delivery station 14 where autoID label reader 18 reads autoID label 34 to determine the identification number. Delivery station 14 provides access to the product or service if the identification number is in transaction data 16.

Delivery station 14 primarily includes computer 40, autoID label reader 42, and display 44. Computer 40 executes verification software 50, which verifies that autoID label 34 is in transaction data 16. Verification software 50 also obtains the terms of the transaction from transaction data 16.

AutoID label reader 42 reads autoID label 34 and sends the identification number to computer 40.

Delivery station 14 may also include delivery device 46 for automated delivery of products or services to customers.

For example, delivery device 46 may include a fountain drink dispenser for reading an autoID label 34 affixed to a cup provided to the customer at the time of purchase. Verification software 50 interrogates autoID label 34 to determine the type of drink to dispense and the number of refills allowed or a time period allowed.

In the case of services, delivery device 46 may include a gate, turnstile, or other device that grants customer access to a service following reading of an autoID label 34 affixed to a ticket, card, bracelet or other device provided to the customer following payment.

At least one of payment station 12 and delivery station 14 is a self-service station. If an operator is located at delivery station 14 to support verification, delivery station 14 may also include input device 48.

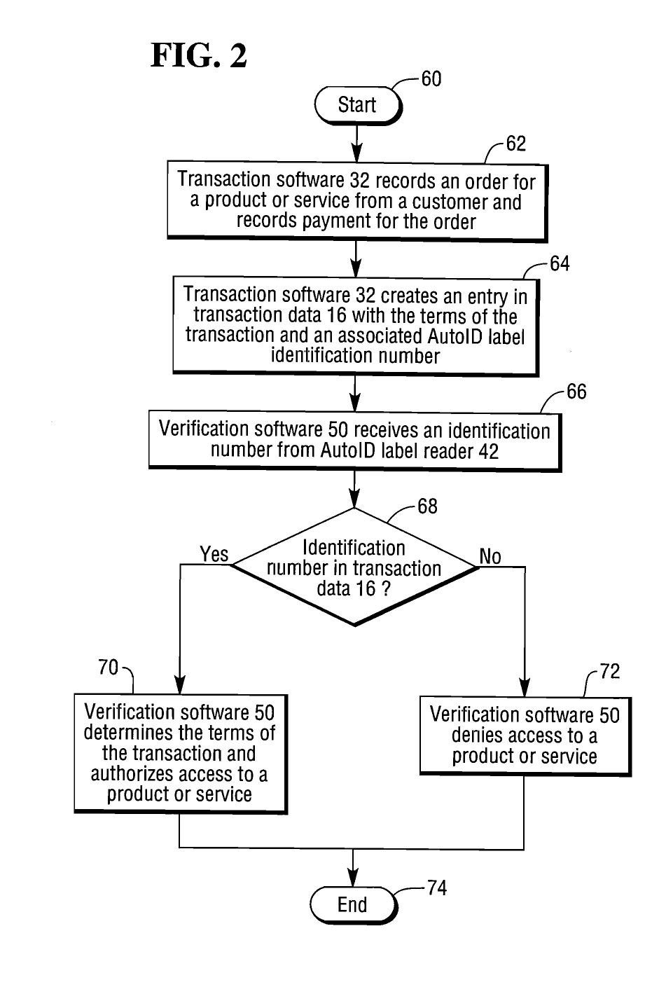

With reference to FIG. 2, a self-service transaction method begins with START 60.

In step 62, transaction software 32 records an order for a product or service from a customer and records payment for the order.

In step 64, transaction software 32 creates an entry in transaction data 16 with the terms of the transaction and an associated identification number.

In one example embodiment, payment station 12 is an assisted-service payment station. Transaction software 32 stores the terms of the transaction and an identification number of an autoID label 34 provided to a customer by an operator in transaction data 16. AutoID label reader 28 obtains the identification number and sends it to transaction software 32.

In another example embodiment, payment station 12 is a self-service payment station. Transaction software 32 stores the terms of the transaction and an identification number of an autoID label 34 obtained from a predetermined order of identification numbers in transaction data 16. Transaction software 32 activates autoID label dispenser 30 to dispense autoID label 34.

In step 66, verification software 50 receives an identification number from autoID label reader 42.

In step 68, verification software 50 determines whether the identification number may be found in transaction data 16. If so, operation proceeds to step 70. Otherwise, operation proceeds to step 72.

In step 70, verification software 50 determines the terms of the transaction and authorizes access to a product or service. Verification software 50 may also display an indication.

In one example embodiment, delivery station 14 is an assisted-service delivery station. An operator provides access to product or access.

In another example embodiment, delivery station 14 is a self-service delivery station. Verification software 50 activates delivery device 46 to provide access to a product or service.

In step 72, verification software 50 denies access to a product or service. Verification software 50 may also display an indication.

In one example embodiment, delivery station 14 is an assisted-service delivery station. An operator sees an indication through display 44 that verification software 50 has denied access to the product or service provides access to product or access.

In another example embodiment, delivery station 14 is a self-service delivery station. A customer sees an indication through display 44 that verification software 50 has denied access to the product or service provides access to product or access.

Operation ends at step 74.

Although particular reference has been made to certain embodiments, variations and modifications are also envisioned within the spirit and scope of the following claims.

1. A method of completing a transaction comprising:
recording an order from a customer by a first computer;
processing payment for the order from the customer by the first computer;
storing terms of the order with an order identification number by the first computer;
providing an order identifier associated with the order identification number;
reading the order identifier by a second computer to determine the order identification number;
accessing the terms of the order using the order identification number by the second computer; and
authorizing a delivery to the customer by the second computer based upon the terms of the order.

2. The method of claim 1, wherein the first computer comprises an assisted-service transaction computer.

3. The method of claim 1, wherein the first computer comprises a self-service transaction computer.

4. The method of claim 1, wherein the providing step comprises dispensing the order identifier.

5. The method of claim 1, wherein the order identifier is a barcode label and wherein the reading step comprises reading the barcode label.

6. The method of claim 1, wherein the order identifier is a radio frequency identification label and wherein the reading step comprises reading the radio frequency identification label.

7. The method of claim 1, wherein the second computer comprises an assisted-service transaction computer.

8. The method of claim 1, wherein the second computer comprises a self-service transaction computer.

9. A transaction system comprising:
a payment station including a first computer for recording an order from a customer, for processing payment for the order from the customer, for storing terms of the order with an order identification number, for providing an order identifier associated with the order identification number; and
a delivery station including a second computer for reading the order identifier to determine the order identification number, for accessing the terms of the order using the order identification number, for authorizing a delivery to the customer based upon the terms of the order.

10. The system of claim 9, wherein the payment station further comprises a dispenser for dispensing the order identifier.

11. The system of claim 10, wherein the order identifier is affixed to a cup and the dispenser comprises a cup dispenser.

12. The method of claim 9, wherein the payment station comprises an assisted-service transaction station.

13. The method of claim 9, wherein the payment station comprises a self-service transaction station.

14. The method of claim 9, wherein the order identifier is a barcode label and wherein the delivery station further comprises a barcode reader for reading the barcode label.

15. The method of claim 9, wherein the order identifier is a radio frequency identification label and wherein the delivery station further comprises a radio frequency identification label reader for reading the radio frequency identification label.

16. The method of claim 9, wherein the delivery station computer comprises an assisted-service transaction station.

17. The method of claim 9, wherein the delivery station comprises a self-service transaction station.
